(19) United States
(12) Patent Application Publication
(10) Pub. No.: US 2021/0223966 A1
(43) Pub. Date: Jul. 22, 2021

(54) STORAGE SYSTEM AND CONTROL METHOD OF STORAGE SYSTEM

(71) Applicant: HITACHI, LTD., Tokyo (JP)

(72) Inventors: Takayuki FUKATANI, Tokyo (JP); Mitsuo HAYASAKA, Tokyo (JP)

(21) Appl. No.: 17/008,954

(22) Filed: Sep. 1, 2020

(30) Foreign Application Priority Data
Jan. 16, 2020 (JP) 2020-004910

(51) Int. Cl. G06F 3/06

(52) U.S. Cl. CPC G06F 3/0617; G06F 3/067; G06F 3/0647; G06F 3/0644

(57) ABSTRACT

To reduce load concentration due to failover. A distributed storage system includes: a plurality of distributed FS servers; and one or more shared storage arrays. The distributed FS servers include logical nodes, which are components of a logical distributed file system, the plurality of logical nodes of the plurality of servers form a distributed file system in which a storage pool is provided, and anyone of the logical nodes processes user data input to and output from the storage pool and inputs and outputs the user data to and from the shared storage array, and the logical node is configured to migrate between the distributed FS servers.

### BACKGROUND OF THE INVENTION

### 1. Field of the Invention

The present invention relates to a storage system and a control method of a storage system.

### 2. Description of the Related Art

As a storage destination of large-capacity data for artificial intelligence (AI) and big data analysis, a scale-out type distributed storage system whose capacity and performance can be expanded at low cost is widespread. As data to be stored in a storage increases, a storage data capacity per node also increases, and a data rebuilding time at the time of recovery of a server failure is lengthened, which leads to a decrease in reliability and availability.

US Patent Application Publication 2015/121131 specification (Patent Literature 1) discloses a method in which, in a distributed file system (hereinafter referred to as distributed FS) including a large number of servers, data stored in a built-in disk is made redundant between servers and only service is failed over to another server when the server fails. The data stored in the failed server is recovered from redundant data stored in another server after the failover.

U.S. Pat. No. 7,930,587 specification (Patent Literature 2) discloses a method of, in a network attached storage (NAS) system using a shared storage, failing over service by switching an access path for a logical unit (LU) of a shared storage storing user data from a failed server to a failover destination server when the server fails. In this method, by switching the access path of the LU to the recovered server after recovery of the server failure, it is possible to recover from failure without data rebuilding, but unlike the distributed storage system shown in Patent Literature 1, it is impossible to scale out capacity and performance of a user volume in proportion to the number of servers.

In the distributed file system in which data is redundant among a large number of servers as shown in Patent Literature 1, data rebuilding is required at the time of failure recovery. In the data rebuilding, it is necessary to rebuild data for a recovered server based on the redundant data on other servers via a network, which increases a failure recovery time.

In the method disclosed in Patent Literature 2, by using the shared storage, the user data can be shared among the servers, and failover and failback of the service due to the switching of the path of the LU become possible. In this case, since the data is in the shared storage, the data rebuilding at the time of the server failure is not required, and the failure recovery time can be shortened.

However, in the distributed file system constituting a huge storage pool across all servers, load distribution after the failover is a problem. In the distributed file system, in order to distribute load evenly among the servers, when the service of the failed server is taken over to another server, the load of the failover destination server is twice that of another server. As a result, the failover destination server becomes overloaded and access response time deteriorates.

The LU during the failover is in a state in which the LU cannot be accessed from another server. In the distributed file system, since the data is distributed and disposed across the servers, if there is an LU that cannot be accessed, an IO of the entire storage pool is affected. When the number of servers constituting the storage pool increases, frequency of the failover increases, and availability of the storage pool is reduced.

### SUMMARY OF THE INVENTION

The invention has been made in view of the above circumstances, and an object thereof is to provide a storage system capable of reducing load concentration due to failover.

In order to achieve the above object, a storage system according to a first aspect includes: a plurality of servers; and a shared storage storing data and shared by the plurality of servers, in which each of the plurality of servers includes one or a plurality of logical nodes, the plurality of logical nodes of the plurality of servers form a distributed file system in which a storage pool is provided, and any one of the logical nodes processes user data input to and output from the storage pool, and inputs and outputs the user data to and from the shared storage, and the logical node is configured to migrate between the servers.

According to the invention, load concentration due to failover can be reduced.

### BRIEF DESCRIPTION OF THE DRAWINGS

FIG. 1 is a block diagram showing an example of a failover method of a storage system according to a first embodiment.

FIG. 2 is a block diagram showing a configuration example of the storage system according to the first embodiment.

FIG. 3 is a block diagram showing a hardware configuration example of a distributed FS server of FIG. 2.

FIG. 4 is a block diagram showing a hardware configuration example of a shared storage array of FIG. 2.

FIG. 5 is a block diagram showing a hardware configuration example of a management server of FIG. 2.

FIG. 6 is a block diagram showing a hardware configuration example of a host server of FIG. 2.

FIG. 7 is an example of logical node control information in FIG. 1.

FIG. 8 is a diagram showing an example of a storage pool management table of FIG. 3.

FIG. 9 is a diagram showing an example of a RAID control table of FIG. 3.

FIG. 10 is a diagram showing an example of a failover control table of FIG. 3.

FIG. 11 is a diagram showing an example of an LU control table of FIG. 4.

FIG. 12 is a diagram showing an example of an LU management table of FIG. 5.

FIG. 13 is a diagram showing an example of a server management table of FIG. 5.

FIG. 14 is a diagram showing an example of an array management table of FIG. 5.

FIG. 15 is a flowchart showing an example of a storage pool creation processing of the storage system according to the first embodiment.

FIG. 16 is a sequence diagram showing an example of a failover processing of the storage system according to the first embodiment.

FIG. 17 is a sequence diagram showing an example of a failback processing of the storage system according to the first embodiment.

FIG. 18 is a flowchart showing an example of a storage pool expansion processing of the storage system according to the first embodiment.

FIG. 19 is a flowchart showing an example of a storage pool reduction processing of the storage system according to the first embodiment.

FIG. 20 is a diagram showing an example of a storage pool creation screen of the storage system according to the first embodiment.

FIG. 21 is a block diagram showing an example of a failover method of a storage system according to a second embodiment.

FIG. 22 is a flowchart showing an example of a storage pool creation processing of the storage system according to the second embodiment.

### DESCRIPTION OF THE PREFERRED EMBODIMENTS

Hereinafter, embodiments will be described with reference to the drawings. It should be noted that the embodiments described below do not limit the invention according to the claims, and all of the elements and combinations thereof described in the embodiments are not necessarily essential to the solution to the problem.

In the following description, although various kinds of information may be described in the expression of “aaa table”, various kinds of information may be expressed by a data structure other than the table. The “aaa table” may also be called “aaa information” to show that it does not depend on the data structure.

In the following description, a “network I/F” may include one or more communication interface devices. The one or more communication interface devices may be one or more same kinds of communication interface devices (for example, one or more network interface cards (NICs)), or may be two or more different kinds of communication interface devices (for example, the NIC and a host bus adapter (HBA)).

In the following description, the configuration of each table is an example, and one table may be divided into two or more tables, or all or a part of the two or more tables may be one table.

In the following description, “storage device” is a physical non-volatile storage device (for example, an auxiliary storage device such as, a hard disk drive (HDD), a solid state drive (SSD), or a storage class memory (SCM)).

A “memory” includes one or more memories in the following description. At least one memory may be a volatile memory or a non-volatile memory. The memory is mainly used in a processing executed by a processor unit.

In the following description, although there is a case where the processing is described using a “program” as a subject, the program is executed by a central processing unit (CPU) to perform a determined processing appropriately using a storage unit (for example, a memory) and/or an interface unit (for example, a port), so that the subject of the processing may be a program. The processing described using the program as the subject may be the processing performed by a processor unit or a computer (for example, a server) which includes the processor unit. A controller (storage controller) may be the processor unit itself, or may include a hardware circuit which performs some or all of the processing performed by the controller. The program may be installed on each controller from a program source. The program source may be, for example, a program distribution server or a computer-readable (for example, non-transitory) storage medium. Two or more programs may be implemented as one program, or one program may be implemented as two or more programs in the following description.

In the following description, an ID is used as identification information of an element, but instead of that or in addition to that, other kinds of identification information may be used.

In the following description, when the same kind of element is described without distinction, a common number in the reference numeral is used, and when the same kind of element is separately described, the reference numeral of the element may be used.

In the following description, a distributed file system includes one or more physical computers (nodes) and storage arrays. The one or more physical computers may include at least one among the physical nodes and the physical storage arrays. At least one physical computer may execute a virtual computer (for example, a virtual machine (VM)) or execute software-defined anything (SDx). For example, a software defined storage (SDS) (an example of a virtual storage device) or a software-defined datacenter (SDDC) can be adopted as the SDx.

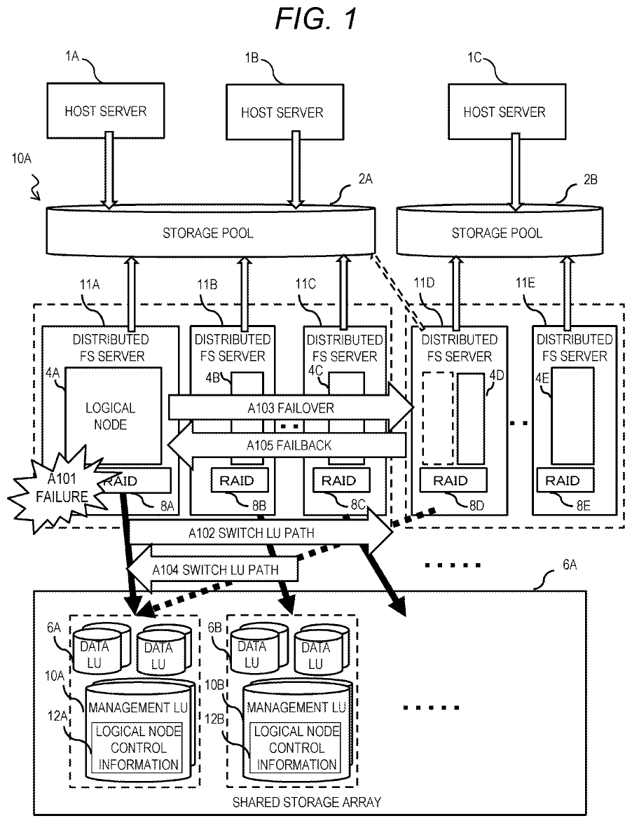

FIG. 1 is a block diagram showing an example of a failover method of a storage system according to a first embodiment.

In FIG. 1, a distributed storage system 10A includes N (N is an integer of two or more) distributed FS servers 11A to 11E, and a shared storage array 6A including one or more shared storages. The distributed storage system 10A constructs a distributed file system in which a file system for managing files is distributed to N distributed FS servers 11A to 11E based on logical management units. On the distributed FS servers 11A to 11E, logical nodes 4A to 4E, which are components of a logical distributed file system, are respectively provided, and there is one logical node for each of the distributed FS servers 11A to 11E in an initial state. The logical node is the logical management unit of the distributed file system and is used in a configuration of a storage pool. The logical nodes 4A to 4E operate as one node constituting the distributed file system like physical servers, but differ from the physical servers in that the logical nodes are not physically bound to the specific distributed FS servers 11A to 11E.

The shared storage array 6A can be individually referred to by the N distributed FS servers 11A to 11E, and stores a logical unit (hereinafter, the logical unit may be referred to as an LU) for taking over the logical nodes 4A to 4E of different distributed FS servers 11A to 11E among the distributed FS servers 11A to 11E. The shared storage array 6A includes data LU 6A, 6B, . . . for storing user data for each of the logical nodes 4A to 4E, and management LU 10A, 10B, . . . for storing logical node control information 12A, 12B, . . . for each of the logical nodes 4A to 4E. Each of the logical node control information 12A, 12B, . . . is information necessary for constituting the logical nodes 4A to 4E on the distributed FS servers 11A to 11E.

The distributed file system 10A includes one or more distributed FS servers and provides a storage pool to a host server. At this time, one or more logical nodes are allocated to each storage pool. In FIG. 1, a storage pool 2A includes one or more logical nodes including the logical nodes 4A to 4C, and a storage pool 2B includes one or more logical nodes including the logical nodes 4D and 4E. The distributed file system provides host with one or more storage pools that can be referred to from a plurality of hosts. For example, the distributed file system provides the storage pool 2A to host servers 1A and 1B, and provides the storage pool 2B to a host server 1C.

In both storage pools 2A and 2B, the plurality of data LU 6A, 6B, . . . stored in the shared storage array 6A are implemented as redundant array of inexpensive disks (RAID) 8A to 8E in each of the distributed FS servers 11A to 11E, thereby making data redundant. Redundancy is performed for each of the logical nodes 4A to 4E, and data redundancy between the distributed FS servers 11A to 11E is not performed.

The distributed storage system 10A performs a failover when a failure occurs in each of the distributed FS servers 11A to 11E, and performs a failback after failure recovery of the distributed FS servers 11A to 11E. At this time, the distributed storage system 10A selects a distributed FS server other than distributed FS servers constituting the same storage pool as a failover destination.

For example, the distributed FS servers 11A to 11C constitute the same storage pool 2A, and the distributed FS servers 11D and 11E constitute the same storage pool 2B. At this time, when a failure occurs in any one of the distributed FS servers 11A to 11C, one of the distributed FS servers 11D and 11E is selected as the failover destination of the logical node of the distributed FS server in which the failure occurs. For example, when a failure occurs in the distributed FS server 11A, service is continued by causing the logical node 4A of the distributed FS server 11A to perform the failover to the distributed FS server 11D.

Specifically, it is assumed that the distributed FS server 11A becomes unable to respond due to a hardware failure or a software failure, and access to the data managed by the distributed FS server 11A is disabled (A101).

Next, one of the distributed FS servers 11B and 11C detects the failure of the distributed FS server 11A. The distributed FS servers 11B and 11C that detect the failure select the distributed FS server 11D having a lowest load among the distributed FS servers 11D and 11E not included in the storage pool 2A as the failover destination. The distributed FS server 11D switches LU paths of the data LU 6A and the management LU 10A allocated to the logical node 4A of the distributed FS server 11A to itself and attaches the LU paths (A102). The attachment referred to here is a processing in which a program of the distributed FS server 11A is in a state in which the corresponding LU can be accessed. The LU path is an access path for accessing the LU.

Next, the distributed FS server 11D resumes the service by starting the logical node 4A on the distributed FS server 11D by using the data LU 6A and the management LU 10A attached at A102 (A103).

Next, after the failure recovery of the distributed FS server 11A, the distributed FS server 11D stops the logical node 4A and detaches the data LU 6A and the management LU 10A allocated to the logical node 4A (A104). The detachment here is a processing in which all write data of the distributed FS server 11D is reflected in the LU and then the LU cannot be accessed from a program of the distributed FS server 11D. Thereafter, the distributed FS server 11A attaches the data LU 6A and the management LU 10A allocated to the logical node 4A to the distributed FS server 11A.

Next, the distributed FS server 11A resumes the service by starting the logical node 4A on the distributed FS server 11A by using the data LU 6A and the management LU 10A attached at A104 (A105).

As described above, according to the first embodiment described above, due to the failover and failback by switching the LU paths, the data redundancy is not required between the distributed FS servers 11A to 11E, and data rebuild is not required when a server fails. As a result, a recovery time at the time of failure occurrence of the distributed FS server 11A can be reduced.

According to the first embodiment described above, by selecting the distributed FS server 11D other than the distributed FS servers 11B and 11C constituting the same storage pool 2A with the failed distributed FS server 11A as the failover destination, load concentration of the distributed FS servers 11B and 11C can be prevented.

In the above first embodiment, an example in which the distributed FS server has RAID control is shown, but this is merely an example. In addition, a configuration in which the shared storage array 6A has the RAID control and the LU is made redundant is also possible.

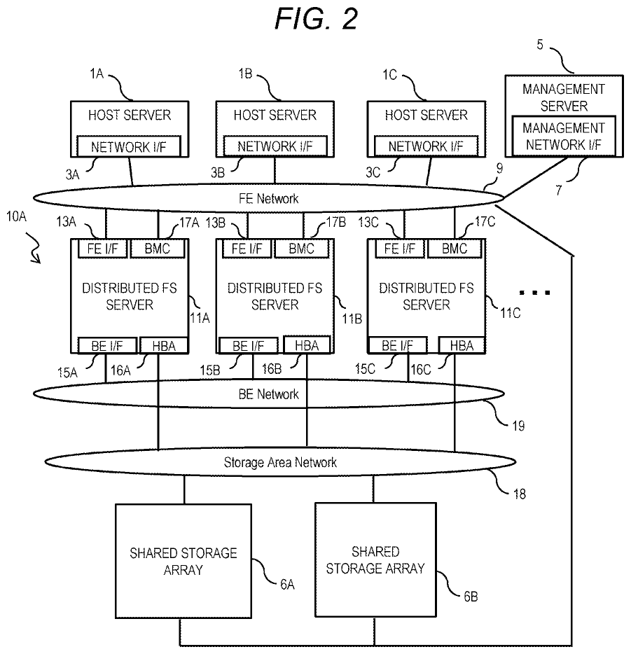

FIG. 2 is a block diagram showing a configuration example of the storage system according to the first embodiment.

In FIG. 2, the distributed storage system 10A includes a management server 5, N distributed FS servers 11A to 11C . . . , and one or more shared storage arrays 6A and 6B. One or more host servers 1A to 1C connect to the distributed storage system 10A.

The host servers LA to 1C, the management server 5, and the distributed FS servers 11A to 11C . . . are connected via a front end (FE) network 9. The distributed FS servers 11A to 11C . . . are connected to each other via a back end (BE) network 19. The distributed FS servers 11A to 11C . . . and the shared storage arrays 6A and 6B are connected via a storage area network (SAN) 18.

Each of the host servers 1A to 1C is a client of the distributed FS servers 11A to 11C The host servers 1A to 1C include network I/Fs 3A to 3C respectively. The host servers 1A to 1C are connected to the FE network 9 via the network I/Fs 3A to 3C respectively, and issue a file I/O to the distributed FS servers 11A to 11C . . . . At this time, several protocols for a file I/O interface via a network such as network file system (NFS), common internet file system (CIFS), and apple filing protocol (AFP) can be used.

The management server 5 is a server for managing the distributed FS servers 11A to 11C and the shared storage arrays 6A and 6B. The management server 5 includes a management network I/F 7. The management server 5 is connected to the FE network 9 via the management network I/F 7, and issues a management request to the distributed FS servers 11A to 11C and the shared storage arrays 6A and 6B. As a communication form of the management request, command execution via secure shell (SSH) or representational state transfer application program interface (REST API) is used. The management server 5 provides an administrator with a management interface such as a command line interface (CLI), a graphical user interface (GUI), or the REST API.

The distributed FS servers 11A to 11C . . . constitute a distributed file system that provides a storage pool which is a logical storage area for each of the host servers 1A to 1C. The distributed FS servers 11A to 11C . . . include FE I/Fs 13A to 13C . . . , BE I/Fs 15A to 15C HBAs 16A to 16C . . . , and baseboard management controllers (BMCs) 17A to 17C . . . , respectively. Each of the distributed FS servers 11A to 11C . . . is connected to the FE network 9 via the FE I/Fs 13A to 13C . . . , and processes the file I/O from each of the host servers 1A to 1C and the management request from the management server 5. Each of the distributed FS servers 11A to 11C . . . is connected to SAN 18 via the HBAs 16A to 16C . . . , and stores user data and control information in the storage arrays 6A and 6B. Each of the distributed FS servers 11A to 11C . . . is connected to BE network 19 via the BE I/Fs 15A to 15C . . . , and the distributed FS servers 11A to 11C . . . communicate with each other. Each of the distributed FS servers 11A to 11C . . . can perform power supply operation from outside during normal time and when failure occurs via the baseboard management controllers (BMCs) 17A to 17C . . . respectively.

Small computer system interface (SCSI), iSCSI, or non-volatile memory express (NVMe) can be used as a communication protocol of the SAN 18, and fiber channel (FC) or Ethernet can be used as a communication medium. Intelligent platform management interface (IPMI) can be used as the communication protocol of the BMCs 17A to 17C . . . . The SAN 18 need not be separate from the FE network 9. Both the FE network 9 and the SAN 18 can be merged.

Regarding the BE network 19, each of the distributed FS servers 11A to 11C . . . uses the BE I/Fs 15A to 15C, and communicates with other distributed FS servers 11A to 11C . . . via the BE network 19. The BE network 19 may exchange metadata or may be used for a variety of other purposes. The BE network 19 need not be separate from the FE network 9. Both the FE network 9 and the BE network 19 can be merged.

The shared storage arrays 6A and 6B provide the LU as the logical storage area for storing user data and control information managed by the distributed FS servers 11A to 11C . . . , to the distributed FS servers 11A to 11C . . . , respectively.

In FIG. 2, the host servers 1A to 1C and the management server 5 are shown as servers physically different from the distributed FS servers 11A to 11C . . . , but this is merely an example. Alternatively, the host servers 1A to 1C and the distributed FS servers 11A to 11C . . . may share the same server, or the management server 5 and the distributed FS servers 11A to 11C . . . may share the same server.

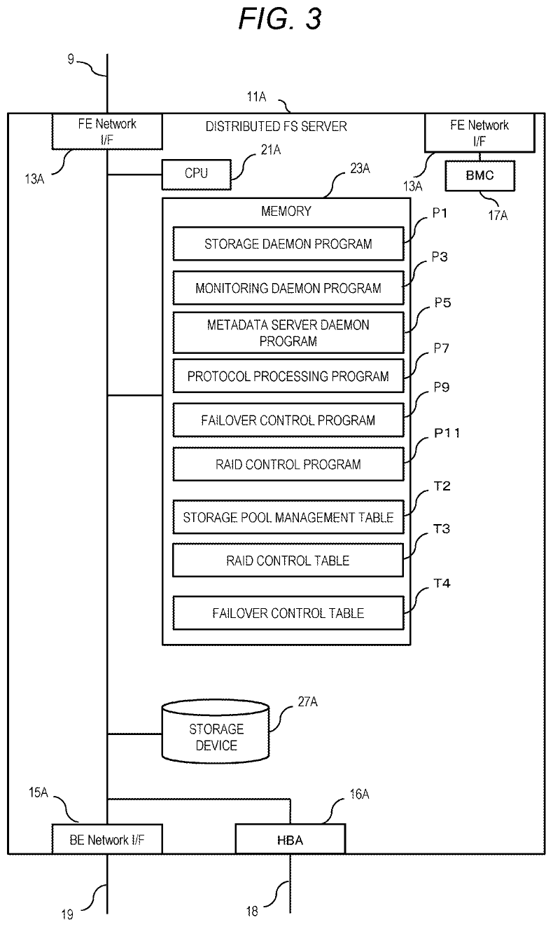

FIG. 3 is a block diagram showing a hardware configuration example of the distributed FS server of FIG. 2. In FIG. 3, the distributed FS server 11A of FIG. 2 is taken as an example, but other distributed FS servers 11B, 11C . . . , may be configured in the same manner.

In FIG. 3, the distributed FS server 11A includes a CPU 21A, a memory 23A, an FE I/F 13A, a BE I/F 15A, an HBA 16A, a BMC 17A, and a storage device 27A.

The memory 23A holds a storage daemon program P1, a monitoring daemon program P3, a metadata server daemon program P5, a protocol processing program P7, a failover control program P9, a RAID control program P11, a storage pool management table T2, a RAID control table T3, and a failover control table T4.

The CPU 21A provides a predetermined function by processing data in accordance with a program on the memory 23A.

The storage daemon program P1, the monitoring daemon program P3, and the metadata server daemon program P5 cooperate with other distributed FS servers 11B, 11C . . . , and constitute a distributed file system. Hereinafter, the storage daemon program P1, the monitoring daemon program P3, and the metadata server daemon program P5 are collectively referred to as a distributed FS control daemon. The distributed FS control daemon constitutes the logical node 4A which is a logical management unit of the distributed file system on the distributed FS server 11A, and implements a distributed file system in cooperation with the other distributed FS servers 11B, 11C . . . .

The storage daemon program P1 processes the data storage of the distributed file system. One or more storage daemon programs P1 are allocated to each logical node, and each one is responsible for read and write of data for each RAID group.

The monitoring daemon program P3 periodically communicates with the distributed FS control daemon group constituting the distributed file system, and performs alive monitoring. The monitoring daemon program P3 may operate with predetermined one or more processes in the entire distributed file system, and may not exist depending on the distributed FS server 11A.

The metadata server daemon program P5 manages metadata of the distributed file system. Here, the metadata refers to name space, an Inode number, access control information, and Quota of a directory of the distributed file system. The metadata server daemon program P5 may also operate only with predetermined one or more processes in the entire distributed file system, and may not exist depending on the distributed FS server 11A.

The protocol processing program P7 receives a request for a network communication protocol such as NFS or SMB, and converts the request into a file I/O to the distributed file system.

The failover control program P9 constitutes a high availability (HA) cluster from two or more distributed FS servers 11A to 11C . . . in the distributed storage system 10A. The HA cluster referred to herein refers to a system configuration in which when a failure occurs in a certain node constituting the HA cluster, service of the failed node is taken over to another server. The failover control program P9 constructs the HA cluster for two or more distributed FS servers 11A to 11C . . . that are accessible to the same shared storage arrays 6A and 6B. A configuration of the HA cluster may be set by the administrator or may be set automatically by the failover control program P9. The failover control program P9 performs alive monitoring of the distributed FS servers 11A to 11C″, and when anode failure is detected, controls the distributed FS control daemon of the failed node to fail over to the other distributed FS servers 11A to 11C.

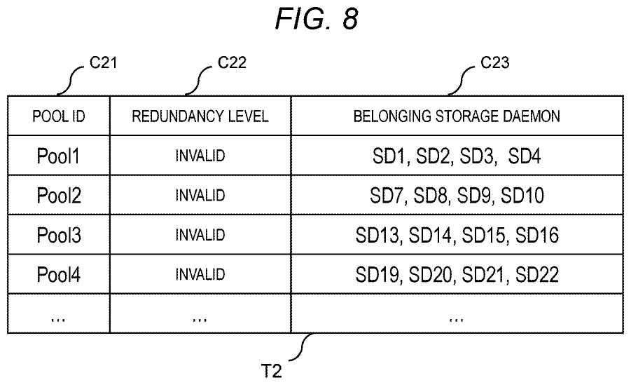

The RAID control program P11 makes the LU provided by the shared storage arrays 6A and 6B redundant, and enables IO to be continued when an LU failure occurs. Various tables will be described later with reference to FIGS. 8 to 10.

The FE I/F 13A, the BE I/F 15A, and the HBA 16A are communication interface devices for connecting to the FE network 9, the BE network 19, and the SAN 18, respectively.

The BMC 17A is a device that provides a power supply control interface of the distributed FS server 11A. The BMC 17A operates independently of the CPU 21A and the memory 23A, and can receive a power supply control request from the outside even when a failure occurs in the CPU 21A and the memory 23A.

The storage device 27A is a non-volatile storage medium storing various programs used in the distributed FS server 11A. The storage device 27A may use the HDD, SSD, or SCM.

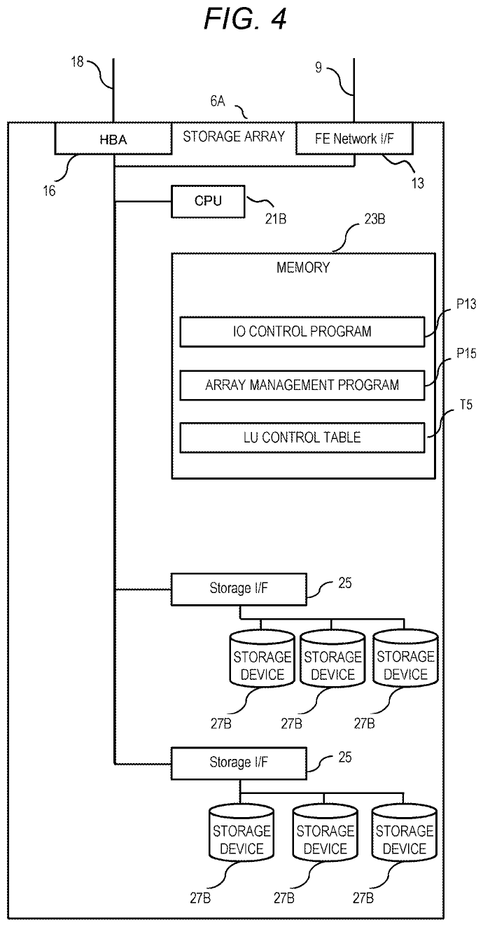

FIG. 4 is a block diagram showing a hardware configuration example of the shared storage array of FIG. 2. In FIG. 4, the shared storage array 6A of FIG. 2 is taken as an example, but the other shared storage array 6B may be configured in the same manner.

In FIG. 4, the storage array 6A includes a CPU 21B, a memory 23B, an FE I/F 13, a storage I/F 25, an HBA 16, and a storage device 27B.

The memory 23B holds an IO control program P13, an array management program P15, and an LU control table T5.

The CPU 21B provides a predetermined function by performing data processing in accordance with the IO control program P13 and the array management program P15.

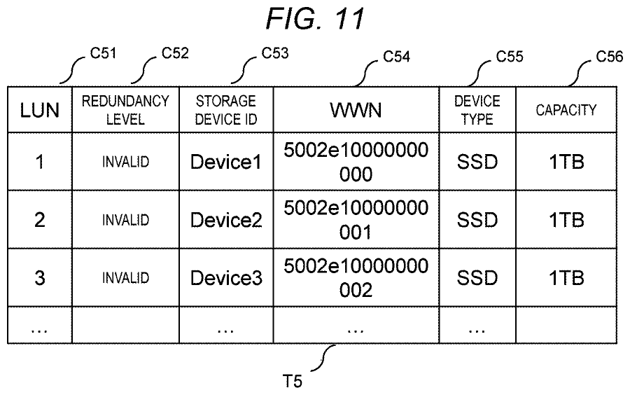

The IO control program P13 processes an I/O request for the LU received via the HBA 16, and reads and writes data stored in the storage device 27B. The array management program P15 creates, expands, reduces, and deletes the LU in the storage array 6A in accordance with an LU management request received from the management server 5. The LU control table T5 will be described later with reference to FIG. 11.

The FE I/F 13 and the HBA 16 are communication interface devices for connecting to the SAN 18 and the FE network 9, respectively.

The storage device 27B records user data and control information stored in the distributed FS servers 11A to 11C . . . , in addition to the various programs used in the storage array 6A. The CPU 21B can read and write data of the storage device 27B via the storage I/F 25. For communication between the CPU 21B and the storage I/F 25, an interface such as fiber channel (FC), serial attached technology attachment (SATA), serial attached SCSI (SAS), or integrated device electronics (IDE) is used. A storage medium of the storage device 27B may be a plurality of types of storage media such as an HDD, an SSD, an SCM, a flash memory, an optical disk, or a magnetic tape.

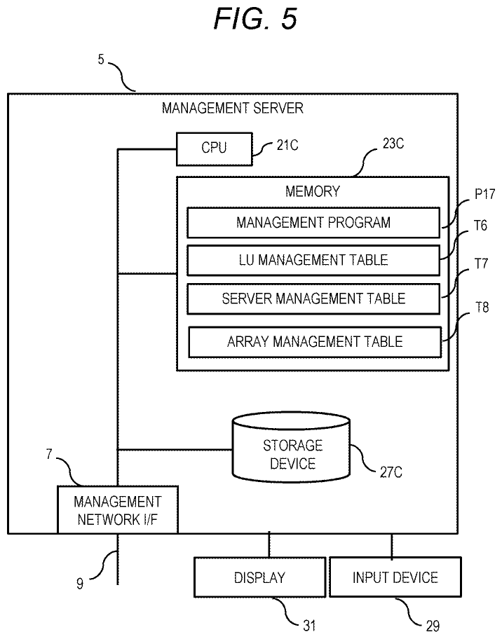

FIG. 5 is a block diagram showing a hardware configuration example of the management server of FIG. 2.

In FIG. 5, the management server 5 includes a CPU 21C, a memory 23C, a management network I/F 7, and a storage device 27C. A management program P17 is connected to an input device 29 and a display 31.

The memory 23C holds the management program P17, an LU management table T6, a server management table T7, and an array management table T8.

The CPU 21C provides a predetermined function by performing data processing in accordance with the management program P17.

The management program P17 issues a configuration change request to the distributed FS servers 11A to 11E . . . and the storage arrays 6A and 6B in accordance with the management request received from the administrator via the management network I/F 7. Here, the management request from the administrator includes creation, deletion, enlargement and reduction of the storage pool, failover and failback of the logical node, and the like. Here, the configuration change request to the distributed FS servers 11A to 11E . . . includes creation, deletion, enlargement and reduction of the storage pool, failover and failback of the logical node, and the like. The configuration change request to the storage arrays 6A and 6B includes creation, deletion, expansion, and reduction of the LU, and addition, deletion, and change of the LU path. Various tables will be described later with reference to FIGS. 11 to 13.

The management network I/F 7 is a communication interface device for connecting to the FE network 9. The storage device 27C is a non-volatile storage medium storing various programs used in the management server 5. The storage device 27C may use the HDD, SSD, SCM, or the like. The input device 29 includes a keyboard, a mouse, or a touch panel, and receives an operation of a user (or an administrator). A screen of the management interface or the like is displayed on the display 31.

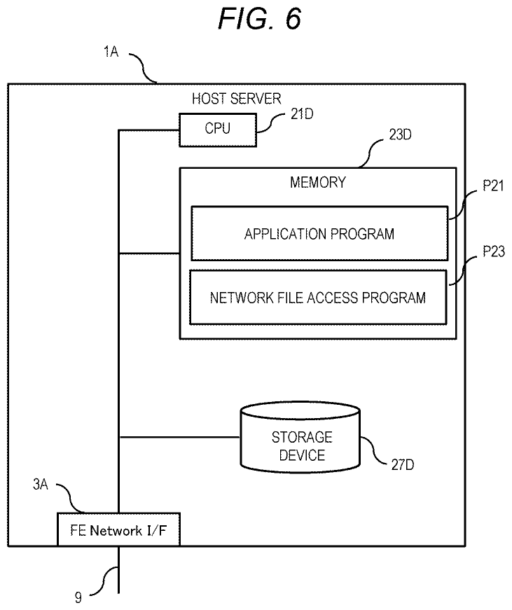

FIG. 6 is a block diagram showing a hardware configuration example of the host server of FIG. 2. In FIG. 6, the host server 1A of FIG. 2 is taken as an example, but other host servers 1B and 1C may be configured in the same manner.

In FIG. 6, the host server 1A includes a CPU 21D, a memory 23D, a network I/F 3A, and a storage device 27D.

The memory 23D holds an application program P21 and a network file access program P23.

The application program P21 performs data processing using the distributed storage system 10A. The application program P21 is, for example, a program such as a relational database management system (RDMS) or a VM Hypervisor.

The network file access program P23 issues the file I/O to the distributed FS servers 11A to 11C . . . , to read and write data from and to the distributed FS servers 11A to 11C . . . . The network file access program P23 provides a client-side control in the network communication protocol, but the invention is not limited to this.

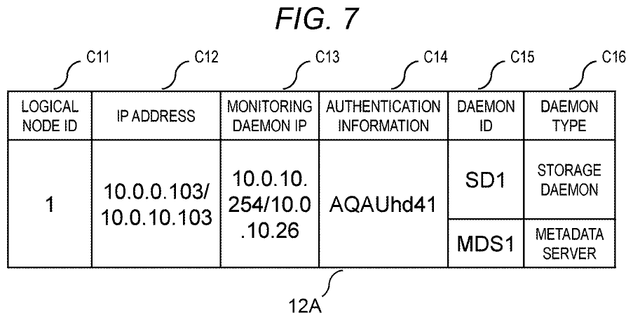

FIG. 7 is an example of the logical node control information in FIG. 1. In FIG. 7, the logical node control information 12A of FIG. 1 is taken as an example, but other logical node control information 12B may be configured in the same manner.

In FIG. 7, the logical node control information 12A stores control information of the logical node managed by the distributed FS control daemon of the distributed FS server 11A of FIG. 1.

The logical node control information 12A includes entries of a logical node ID C11, an IP address C12, a monitoring daemon IP C13, authentication information C14, a daemon ID C15, and a daemon type C16.

The logical node ID C11 stores an identifier of a logical node that can be uniquely identified in the distributed storage system 10A.

The IP address C12 stores an IP address of the logical node indicated by the logical node ID C11. The IP address C12 stores IP addresses of the FE network 9 and the BE network 19 in FIG. 2.

The monitoring daemon IP C13 stores an IP address of the monitoring daemon program P3 of the distributed file system. The distributed FS control daemon participates in the distributed FS by communicating with the monitoring daemon program P3 via the IP address stored in the monitoring daemon IP C13.

The authentication information C14 stores authentication information when the distributed FS control daemon connects to the monitoring daemon program P3. For the authentication information, for example, a public key acquired from the monitoring daemon program P3 may be used, but other authentication information may also be used.

The daemon ID C15 stores an ID of the distributed FS control daemon constituting the logical node indicated by the logical node ID C11. The daemon ID C15 may be managed for each of storage daemon, monitoring daemon, and metadata server daemon, and it is possible to have a plurality of daemon IDs C15 for one logical node.

The daemon type C16 stores a type of each daemon of the daemon ID C15. As the daemon type, any one of the storage daemon, the metadata server daemon, and the monitoring daemon can be stored.

In the present embodiment, IP addresses are used for the IP address C12 and the monitoring daemon IP C13, but this is only an example. Besides, it is also possible to perform communication using a host name.

FIG. 8 is a diagram showing an example of the storage pool management table of FIG. 3.

In FIG. 8, the storage pool management table T2 stores information for the distributed FS control daemon to manage a configuration of the storage pool. All of the distributed FS servers 11A to 11E constituting the distributed file system communicate with each other and hold the storage pool management table T2 having the same contents.

The storage pool management table T2 includes entries of a pool ID C21, a redundancy level C22, and a belonging storage daemon C23.

The pool ID C21 stores an identifier of a storage pool that can be uniquely identified in the distributed storage system 10A in FIG. 1. The pool ID C21 is generated by the distributed FS control daemon for the newly created storage pool.

The redundancy level C22 stores a redundancy level of data of the storage pool indicated by the pool ID C21. Although any one of “invalid”, “replication”, “triplication”, and “erasure code” can be specified at the redundancy level C22, in the present embodiment, “invalid” is specified because no redundancy is performed between the distributed FS servers 11A to 11E.

The belonging storage daemon C23 stores one or more identifiers of the storage daemon program P1 constituting the storage pool indicated by the pool ID C21. The belonging storage daemon C23 sets the management program P17 at the time of creating the storage pool.

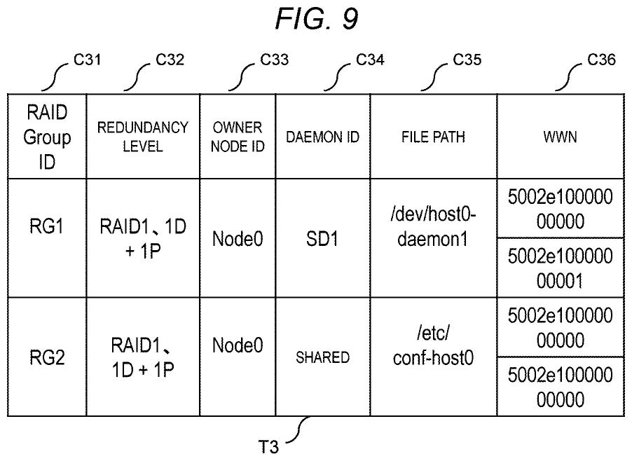

FIG. 9 is a diagram showing an example of a RAID control table of FIG. 3.

In FIG. 9, the RAID control table T3 stores information for the RAID control program P11 to make the LU redundant. The RAID control program P11 communicates with the management server 5 at the time of system boot, and creates the RAID control table T3 based on contents of the LU management table T6. The RAID control program P11 constructs a RAID group based on the LU provided by the shared storage array 6A in accordance with contents of the RAID control table T3, and provides the RAID group to the distributed FS control daemon. Here, the RAID group refers to a logical storage area capable of reading and writing data.

The RAID control table T3 includes entries of a RAID group ID C31, a redundancy level C32, an owner node ID C33, a daemon ID C34, a file path C35, and a WWN C36.

The RAID group ID C31 stores an identifier of a RAID group that can be uniquely identified in the distributed storage system 10A.

The redundancy level C32 stores a redundancy level of the RAID group indicated by the RAID group ID C31. The redundancy level stores a RAID configuration such as RAID1 (nD+mD), RAID5 (nD+1P) or RAID6 (nD+2P). n and m respectively represent the number of data and the number of redundant data in the RAID Group.

The owner node ID C33 stores an ID of the logical node to which the RAID group indicated by the RAID group ID C31 is allocated.

The daemon ID C34 stores an ID of a daemon that uses the RAID group indicated by the RAID group ID C31. When the RAID group is shared by a plurality of daemons, “shared”, which is an ID indicating that the RAID group is shared, is stored.

The file path C35 stores a file path for accessing the RAID group indicated by the RAID group ID C31. A type of file stored in the file path C35 differs depending on a type of daemon that uses the RAID Group. When the storage daemon program P1 uses the RAID group, a path of a device file is stored in the file path C35. When the RAID group is shared among the daemons, a mount path on which the RAID group is mounted is stored.

The WWN C36 stores a world wide name (WWN) that is an identifier for uniquely identifying a logical unit number (LUN) in the SAN 18. The WWN C36 is used when the distributed FS servers 11A to 11E access the LU.

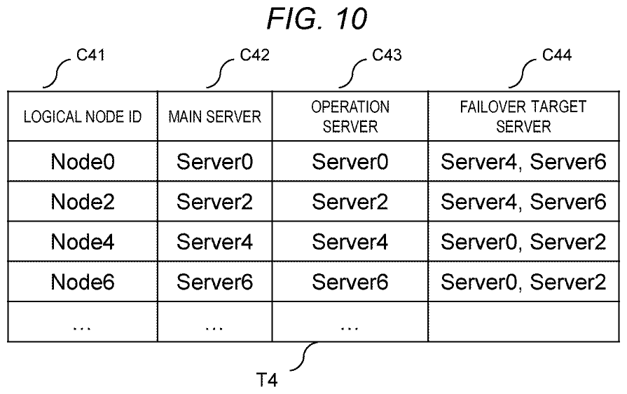

FIG. 10 is a diagram showing an example of the failover control table of FIG. 3.

In FIG. 10, the failover control table T4 stores information for the failover control program P9 to manage operation servers of the logical nodes. The failover control programs P9 of all the nodes constructing the HA cluster communicate with each other, thereby holding the failover control table T4 of the same content at all the nodes.

The failover control table T4 includes entries of a logical node ID C41, a main server C42, an operation server C43, and a failover target server C44.

The logical node ID C41 stores an identifier of the logical node that can be uniquely identified in the distributed storage system 10A. When a server is newly added, the logical node ID sets a name associated with the server by the management program P17. In FIG. 10, for example, the logical node ID is assumed to be Node0 for Server0.

The main server C42 stores server IDs of the distributed FS servers 11A to 11E in which the logical nodes operate in the initial state.

The operation server C43 stores server IDs of the distributed FS servers 11A to 11E in which the logical nodes indicated by the logical node ID C41 operate.

The failover target server C44 stores server IDs of the distributed FS servers 11A to 11E in which the logical nodes indicated by the logical node ID C41 can failover. In the failover target server C44, among the distributed FS servers 11A to 11E constituting the HA cluster, a distributed FS server excluding a distributed FS server constituting the same storage pool is stored. The failover target server C44 is set when the management program P17 creates a volume.

FIG. 11 is a diagram showing an example of the LU control table of FIG. 4.

In FIG. 11, the LU control table T5 stores information for the IO control program P13 and the array management program P15 to manage a configuration of the LU and for an IO request processing for the LU.

The LU control table T5 includes entries of an LUN C51, a redundancy level C52, a storage device ID C53, a WWN C54, a device type C55, and a capacity C56.

The LUN C51 stores a management number of the LU in the storage array 6A. The redundancy level C52 specifies a redundancy level of the LU in the storage array 6A. A value that can be stored in the redundancy level C52 is equal to the redundancy level C32 of the RAID control table T3. In the present embodiment, since the RAID control program P11 of each of the distributed FS servers 11A to 11E makes the LU redundant and the storage array 6A does not perform redundancy, “invalid” is specified.

The storage device ID C53 stores an identifier of the storage device 27B constituting the LU. The WWN C54 stores the world wide name (WWN) that is the identifier for uniquely identifying the LUN in the SAN 18. The WWN C54 is used when the distributed FS server 11 accesses the LU.

The device type C55 stores a type of a storage medium of the storage device 27B constituting the LU. In the device type C55, symbols indicating device types such as “SCM”, “SSD”, and “HDD” are stored. The capacity C56 stores a logical capacity of the LU.

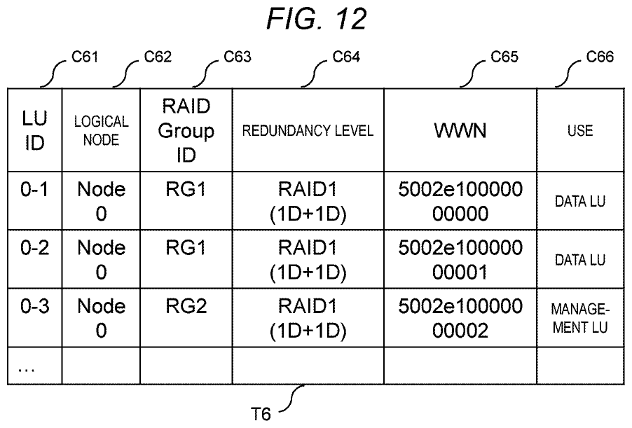

FIG. 12 is a diagram showing an example of the LU management table of FIG. 5.

In FIG. 12, the LU management table T6 stores information for the management program P17 to manage an LU configuration shared by the entire distributed storage system 10A. The management program P17 cooperates with the array management program P15 and the RAID control program P11 to create and delete the LU and allocate the LU to the logical node.

The LU management table T6 includes entries of an LU ID C61, a logical node C62, a RAID group ID C63, a redundancy level C64, a WWN C65, and a use C66.

The LU ID C61 stores an identifier of the LU that can be uniquely identified in the distributed storage system 10A. The LU ID C61 is generated when the management program P17 creates an LU. The logical node C62 enables an identifier of the logical node that owns the LU.

The RAID group ID C63 stores an identifier of a RAID group that can be uniquely identified in the distributed storage system 10A. The RAID group ID C63 is generated when the management program P17 creates a RAID group.

The redundancy level C64 stores a redundancy level of the RAID group. The WWN C65 stores a WWN of the LU. The use C66 stores use of the LU. The use C66 stores “data LU” or “management LU”.

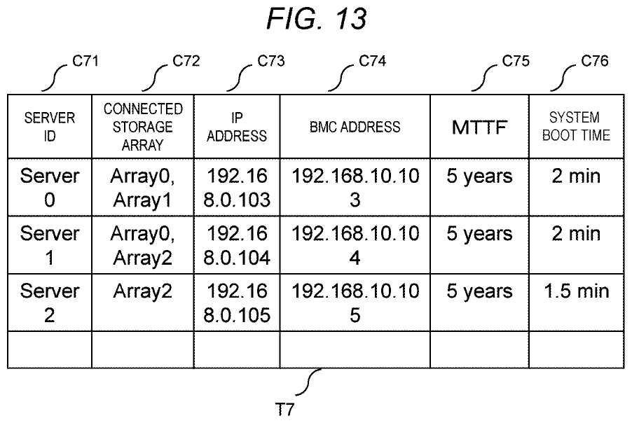

FIG. 13 is a diagram showing an example of the server management table of FIG. 5.

In FIG. 13, the server management table T7 stores configuration information of the distributed FS servers 11A to 11E necessary for the management program P17 to communicate with the distributed FS servers 11A to 11E or to determine configurations of the LU and the RAID group.

The server management table T7 includes entries of a server ID C71, a connected storage array C72, an IP address C73, a BMC address C74, an MTTF C75, and a system boot time C76.

The server ID C71 stores an identifier of the distributed FS servers 11A to 11E that can be uniquely identified in the distributed storage system 10A.

The connected storage array C72 stores an identifier of the storage array 6A that can be accessed from the distributed FS servers 11A to 11E indicated by the server ID C71.

The IP address C73 stores IP addresses of the distributed FS servers 11A to 11E indicated by the server ID C71.

The BMC address C74 stores IP addresses of respective BMCs of the distributed FS servers 11A to 11E indicated by the server ID C71.

The MTTF C75 stores a mean time to failure (MTTF) of the distributed FS servers 11A to 11E indicated by the server ID C71.

The MTTF uses, for example, a catalog value according to the server type.

The system boot time C76 stores a system boot time in a normal state of the distributed FS servers 11A to 11E indicated by the server ID C71. The management program P17 estimates a failover time based on the system boot time C76.

Although the IP address is stored in the IP address C73 and the BMC address C74 in the present embodiment, other host names may be used.

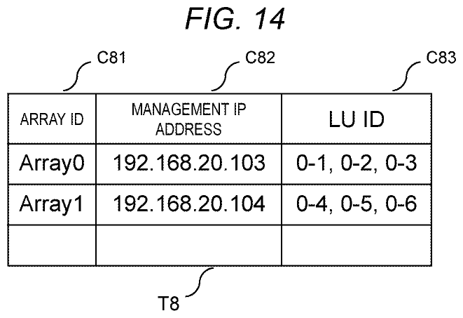

FIG. 14 is a diagram showing an example of the array management table of FIG. 5.

In FIG. 14, the array management table T8 stores configuration information of the storage array 6A for the management program P17 to communicate with the storage array 6A or to determine the configurations of the LU and the RAID group.

The array management table T8 includes entries of an array ID C81, a management IP address C82, and an LUN ID C83.

The array ID C81 stores an identifier of the storage array 6A that can be uniquely identified in the distributed storage system 10A.

The management IP address C82 stores a management IP address of the storage array 6A indicated by the array ID C81. Although an example of storing the IP address is shown in the present embodiment, other host names may be used.

The LU ID C83 stores an ID of the LU provided by the storage array 6A indicated by the array ID C81.

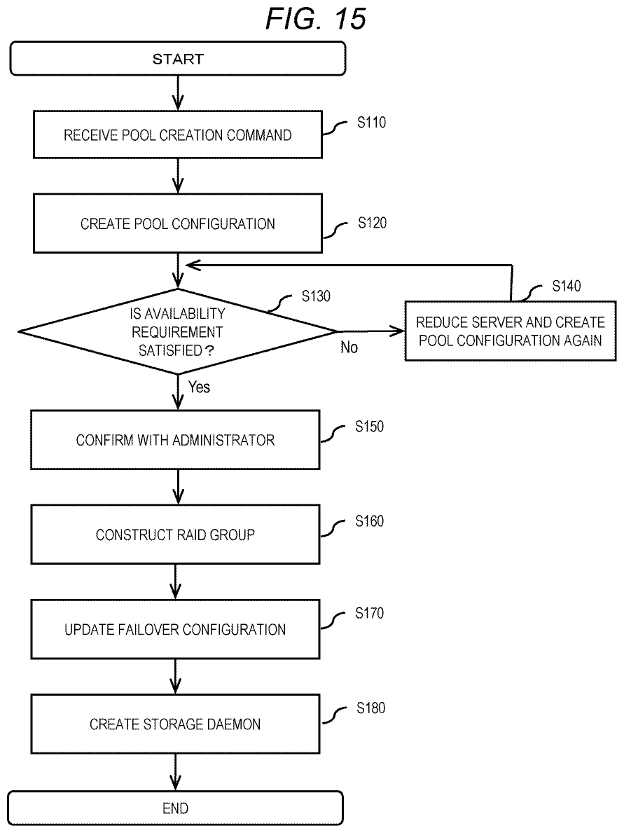

FIG. 15 is a flowchart showing an example of a storage pool creation processing of the storage system according to the first embodiment.

In FIG. 15, upon receiving a storage pool creation request from the administrator, the management program P17 of FIG. 5 creates a storage pool based on load distribution and reliability requirements at the time of failover.

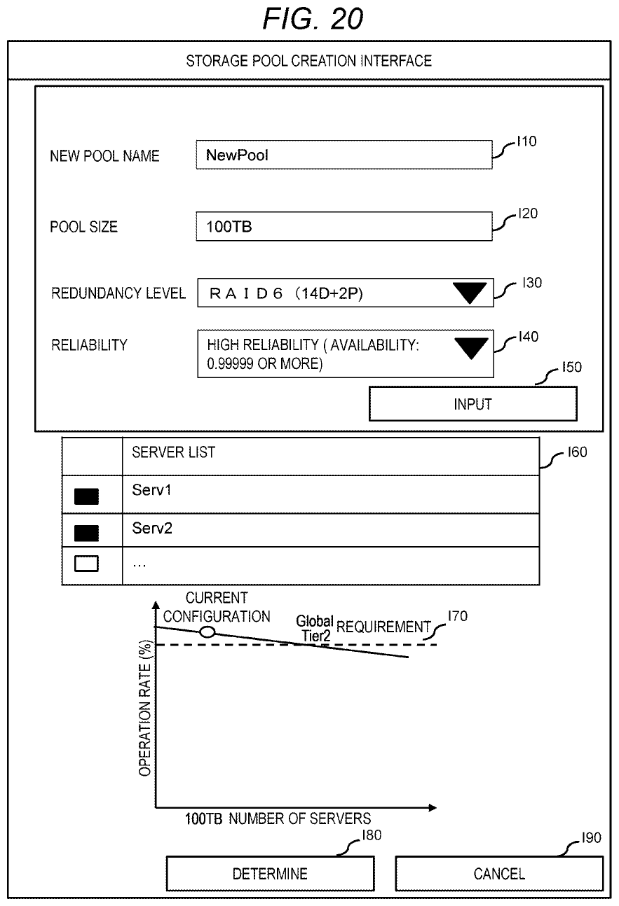

Specifically, the management program P17 receives, from the administrator, the storage pool creation request including a new pool name, a pool size, a redundancy level, and a reliability requirement (S110). The administrator issues the storage pool creation request to the management server 5 through a storage pool creation screen shown in FIG. 20.

Next, the management program P17 creates a storage pool configuration candidate including one or more distributed FS servers (S120). The management program P17 refers to the server management table T7 and selects a node constituting the storage pool. At this time, the management program P17 ensures that a failover destination node at the time of node failure is not a constituent node of the same storage pool by setting the number of the constituent nodes to half or less of distributed FS server groups.

The management program P17 refers to the server management table T7 and ensures that a node connectable to the same storage array as a candidate node is not the constituent node of the same storage pool.

The limitation of the number of constituent nodes is merely an example, and when the number of distributed FS servers is small, the number of constituent nodes may be “the number of distributed FS server groups−1”.

Next, the management program P17 estimates an availability KM of the storage pool and determines whether an availability requirement is satisfied (S130). The management program P17 calculates the availability KM of the storage pool constituted by the storage pool configuration candidates using the following Formula (1).

$$KM = \prod ( \frac{{MTTF}_{server} - F . O . {Time}_{server}}{M T T {F}_{s e r ν e r}} ) \qquad ( Formula 1 )$$

In the Formula, MTTFₛₑᵣᵥₑᵣ represents the MTTF of the distributed FS server, and F.O. Timeₛₑᵣᵥₑᵣ represents failover time (F.O. time) of the distributed FS server. The MTTF of the distributed FS server 11 uses the MTTF C75 of FIG. 13, and the F.O. time uses a value obtained by increasing the system boot time C76 by one minute. The method of estimating the MTTF and F.O. time is an example, and other methods may be used.

The availability requirement is set from the reliability requirement specified by the administrator, and for example, when high reliability is required, the availability requirement is set to 0.99999 or more.

When Formula (1) is not satisfied, the management program. P17 determines that the storage pool configuration candidate does not satisfy the availability requirement, the processing proceeds to S140, and otherwise proceeds to S150.

When the availability requirement is not satisfied, the management program P17 reduces one distributed FS server from the storage pool configuration candidate and creates a new storage pool configuration candidate, and the processing returns to S130 (S140).

When the availability requirement is satisfied, the management program P17 presents a distributed FS server list of the storage pool configuration candidates to the administrator via the management interface (S150). The administrator refers to the distributed FS server list, performs necessary changes, and determines the changed configuration as a storage pool configuration. The management interface for creating the storage pool will be described later with reference to FIG. 20.

Next, the management program P17 determines a RAID group configuration satisfying a redundancy level specified by the administrator (S160). The management program P17 calculates a RAID group capacity per distributed FS server based on a value obtained by dividing a storage pool capacity specified by the administrator by the number of distributed FS servers. The management program P17 instructs the storage array 6A to create an LU constituting the RAID group, and updates the LU control table T5. Thereafter, the management program P17 updates the RAID control table T3 via the RAID control program P11, and constructs the RAID group. Then, the management program P17 updates the LU management table T6.

Next, the management program P17 communicates with the failover control program P9 to update the failover control table T4 (S170). The management program P17 checks the failover target server C44 with respect to the logical node ID C41 having the distributed FS server constituting the storage pool as the main server C42, and when the distributed FS server constituting the storage pool is included, excludes the distributed FS server from the failover target server C44.

Next, the management program P17 instructs the distributed FS control daemon to newly create a storage daemon that uses the RAID group created in S160 (S180). Thereafter, the management program P17 updates distributed FS control information T1 and the storage pool management table T2 via the distributed FS control daemon.

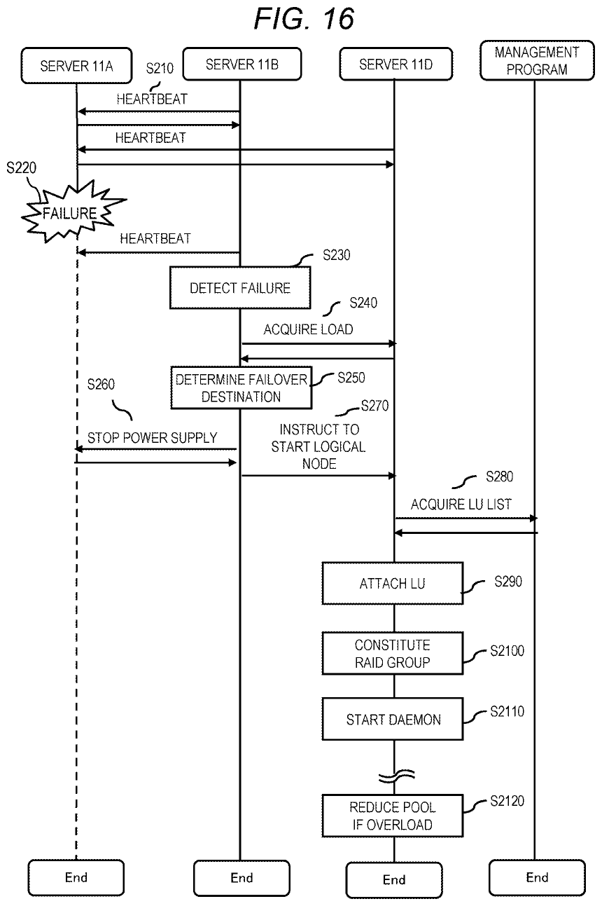

FIG. 16 is a sequence diagram showing an example of a failover processing of the storage system according to the first embodiment. In FIG. 16, the failover control program P9 of the distributed FS servers 11A, 11B, and 11D of FIG. 1 and the processing of the management program P17 of FIG. 5 are extracted and illustrated.

In FIG. 16, mutual alive monitoring is performed by periodically communicating (heartbeat) between the distributed FS servers 11A, 11B, and 11D (S210). At this time, for example, it is assumed that a node failure occurs in the distributed FS server 11A (S220).

When the node failure occurs in the distributed FS server 11A, heartbeat from the distributed FS server 11A is interrupted. At this time, for example, when the heartbeat from the distributed FS server 11A is interrupted, the failover control program P9 of the distributed FS server 11B detects the failure of the distributed FS server 11A (S230).

Next, the failover control program P9 of the distributed FS server 11B refers to the failover control table T4 and acquires a list of failover target servers. The failover control program P9 of the distributed FS server 11B acquires a current load (for example, the number of IOs in the past 24 hours) from all of the failover target servers (S240).

Next, the failover control program P9 of the distributed FS server 11B selects the distributed FS server 11D having the lowest load from load information obtained in S240 as the failover destination (S250).

Next, the failover control program P9 of the distributed FS server 11B instructs the BMC 17A of the distributed FS server 11A to stop power supply of the distributed FS server 11A (S260).

Next, the failover control program P9 of the distributed FS server 11B instructs the distributed FS server 11D to start the logical node 4A (S270).

Next, the failover control program P9 of the distributed FS server 11D inquires of the management server 5 to acquire an LU list describing the LU used by the logical node 4A (S280). The failover control program P9 of the distributed FS server 11D updates the RAID control table T3.

Next, the failover control program P9 of the distributed FS server 11D searches for an LU having the WWN C65 via the SAN 18, and attaches the LU to the distributed FS server 11D (S290).

Next, the failover control program P9 of the distributed FS server 11D instructs the RAID control program P11 to construct a RAID group (S2100). The RAID control program P11 refers to the RAID control table T3 and constructs a RAID group used by the logical node 4A.

Next, the failover control program P9 of the distributed FS server 11D refers to the logical node control information 12A stored in the management LU 10A of the logical node 4A, and starts the distributed FS control daemon for the logical node 4A (S2110).

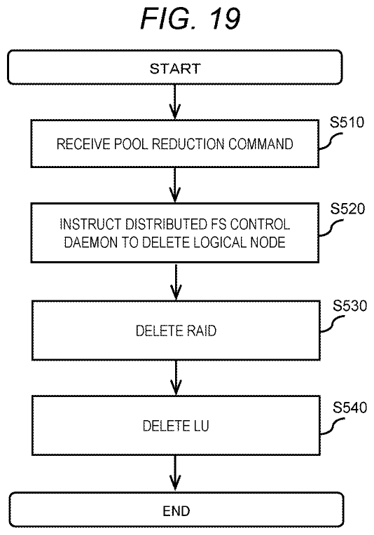

Next, when the distributed FS server 11D is in an overload state and does not failback after a lapse of a certain time (for example, one week) after the failover, the failover control program P9 of the distributed FS server 11D performs a storage pool reduction flow shown in FIG. 19 to remove the logical node 4A from the distributed storage system 10A (S2120). The distributed FS control daemon equalizes the loads by rebalancing the data so that data capacities are equal among the remaining distributed FS servers.

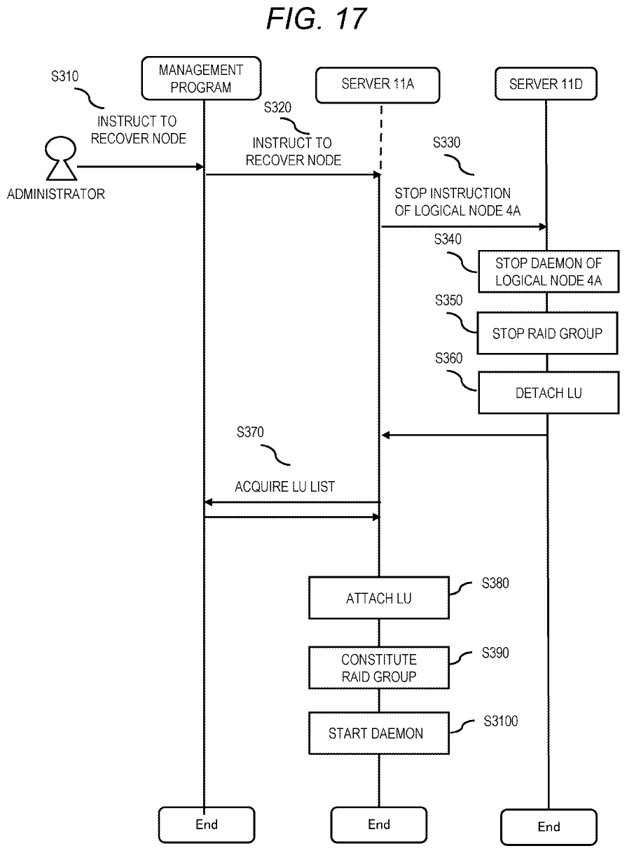

FIG. 17 is a sequence diagram showing an example of a failback processing of the storage system according to the first embodiment. In FIG. 17, the failover control program P9 of the distributed FS servers 11A and 11D of FIG. 1 and the processing of the management program P17 of FIG. 5 are extracted and illustrated.

In FIG. 17, the administrator instructs the management program P17 to recover the node via the management interface after performing the failure recovery on the distributed FS server 11A in which the failure occurs by a maintenance work such as a server replacement or a failure site exchange (S310).

Next, upon receiving a node recovery request from the administrator, the management program P17 issues a node recovery instruction to the distributed FS server 11A in which the failure occurs (S320).

Next, upon receiving the node recovery instruction, the failover control program. P9 of the distributed FS server 11A issues a stop instruction of the logical node 4A to the distributed FS server 11D in which the logical node 4A operates (S330).

Next, upon receiving the stop instruction of the logical node 4A, the failover control program P9 of the distributed FS server 11D stops the distributed FS control daemon allocated to the logical node 4A (S340).

Next, the failover control program P9 of the distributed FS server 11D stops the RAID group used by the logical node 4A (S350).

Next, the failover control program P9 of the distributed FS server 11D detaches the LU used by the logical node 4A from the distributed FS server 11D (S360).

Next, the failover control program P9 of the distributed FS server 11A inquires of the management program P17, acquires a latest LU list used by the logical node 4A, and updates the RAID control table T3 (S370).

Next, the failover control program P9 of the distributed FS server 11A attaches the LU used by the logical node 4A to the distributed FS server 11A (S380).

Next, the failover control program P9 of the distributed FS server 11A refers to the RAID control table T3, and constitutes the RAID group (S390).

Next, the failover control program P9 of the distributed FS server 11A starts the distributed FS control daemon of the logical node 4A (S3100).

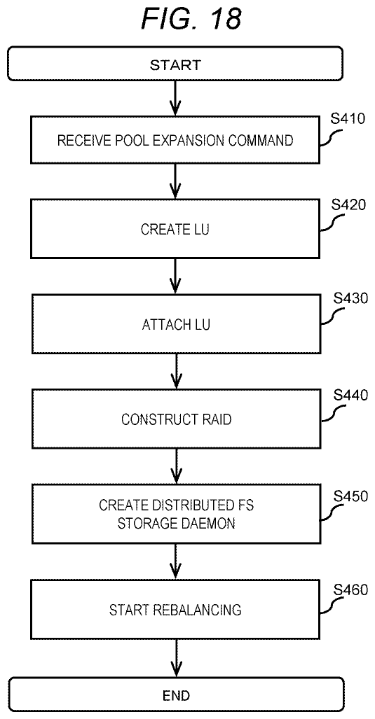

When the logical node 4A is removed in S2120 of FIG. 16, the failed server is recovered by a storage pool expansion flow described later with reference to FIG. 18, instead of the processing shown in FIG. 17.

FIG. 18 is a flowchart showing an example of a storage pool expansion processing of the storage system according to the first embodiment.

In FIG. 18, the administrator can expand the storage pool capacity by instructing the management program P17 to expand the storage pool when the distributed FS server is added or when the storage pool capacity is insufficient. When the storage pool expansion is requested, the management program P17 attaches the data LU having the same capacity as the other servers to the new distributed FS server or the specified existing distributed FS server, and adds the data LU to the storage pool.

Specifically, the management program P17 receives a pool expansion command from the administrator via the management interface (S410). The pool expansion command includes information of the distributed FS server to be newly added to the storage pool and a storage pool ID to be expanded. The management program P17 adds the newly added distributed FS server to the server management table T7 based on the received information.

Next, the management program P17 instructs the storage array 6A to create a data LU having the same configuration as the data LU of the other distributed FS servers constituting the storage pool (S420).

Next, the management program. P17 attaches the data LU created in S420 to the newly added distributed FS server or an existing distributed FS server specified by the administrator (S430).

Next, the management program P17 instructs the RAID control program P11 to constitute a RAID group based on the LU attached in S430 (S440). The RAID control program P11 reflects information of the new RAID group in the RAID control table T3.

Next, the management program. P17 creates a storage daemon for managing the RAID group created in S440 via the storage daemon program P1 and adds the storage daemon to the storage pool (S450). The storage daemon program P1 updates the logical node control information and the storage pool management table T2. In addition, the management program P17 updates the failover target server C44 of the failover control table T4 via the failover control program P9.

Next, the management program P17 instructs the distributed FS control daemon to start rebalancing in the expanded storage pool (S460). The distributed FS control daemon performs data migration between the storage daemons such that capacities of all storage daemons in the storage pool are uniform.

FIG. 19 is a flowchart showing an example of a storage pool reduction processing of the storage system according to the first embodiment.

In FIG. 19, the administrator or the various control programs can remove the distributed FS server by issuing a storage reduction instruction to the management program P17.

Specifically, the management program P17 receives a pool reduction command (S510). The pool reduction command includes a name of the distributed FS server to be removed.

Next, the management program P17 refers to the failover control table T4 and checks the logical node ID using the distributed FS server to be removed as the main server. The management program P17 instructs the distributed FS control daemon to delete the logical node having the logical node ID (S520). The distributed FS control daemon deletes the storage daemon after performing data rebalancing for all the storage daemons on the specified logical node to other storage. The distributed FS control daemon also migrates the monitoring daemon and metadata server daemon of the specified logical node to the other logical nodes. At this time, the distributed FS control daemon updates the storage pool management table T2 and the logical node control information 12A. The management program P17 instructs the failover control program P9 to update the failover control table T4.

Next, the management program P17 instructs the RAID control program P11 to delete the RAID group used by the logical node deleted in S520, and updates the RAID control table T3 (S530).

Next, the management program P17 instructs the storage array 6A to delete the LU used by the deleted logical node (S540). Then, the management program P17 updates the LU management table T6 and the array management table T8.

FIG. 20 is a diagram showing an example of the storage pool creation screen of the storage system according to the first embodiment. A storage pool creation interface displays the storage pool creation screen. The storage pool creation screen may be displayed on the display 31 by the management server 5 in FIG. 5, or may be displayed by a client specifying URL on a Web browser.

In FIG. 20, the storage pool creation screen includes display fields of text boxes I10 and I20, list boxes I30 and I40, an input button I50, a server list I60, a graph I70, a determination button I80, and a cancel button I90.

In the text box I10, the administrator inputs a new pool name.

In the text box I20, the administrator inputs a storage pool size.

The list box I30 specifies a redundancy level of the storage pool to be newly created by the administrator. For the use of the list box I30, “RAID1 (mD+mD)” or “RAID6 (mD+2P)” may be selected, and m may use any value.

The list box I40 specifies reliability of the storage pool to be newly created by the administrator. For the use of the list box I40, “high reliability (availability: 0.99999 or more)”, “normal (availability: 0.9999 or more)” or “not considered” can be selected.

The input button I50 can be pressed by the administrator after inputting in the text boxes I10, I20 and the list boxes I30, I40. When the input button I50 is pressed, the management program P17 starts a storage pool creation flow.

The server list I60 is a list with a radio box indicating a list of distributed FS servers constituting the storage pool. The server list I60 is displayed after reaching S150 of the storage pool creation processing in FIG. 15. In an initial state of this list, the radio box of the storage pool configuration candidate created by the management program P17 is turned on for all the distributed FS servers constituting the distributed storage system 10A. The administrator can change the configuration of the storage pool by switching on and off the radio box.

The graph I70 shows an approximate curve of an availability estimate with respect to the number of servers. When the administrator presses the input button I50 and changes the radio button of the server list I60, the graph I70 is generated using Formula (1), and is displayed on the storage pool creation screen. The administrator can confirm an influence of changing the storage pool configuration by referring to the graph I70.

When the administrator presses the determination button I80, the configuration of the storage pool is determined, and the creation of the storage pool is continued. When the administrator presses the cancel button I90, the configuration of the storage pool is determined, and the creation of the storage pool is canceled.

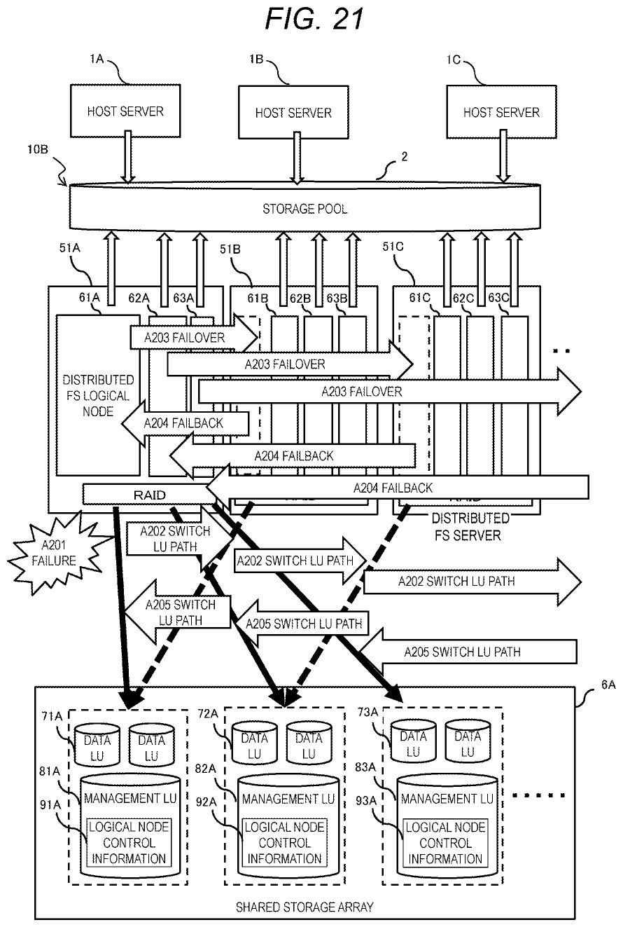

FIG. 21 is a block diagram showing an example of a failover method of a storage system according to a second embodiment. In the second embodiment, load distribution at the time of the failover is implemented by fine-graining the logical node that is a failover unit. In fine-graining the logical nodes, one distributed FS server has a plurality of logical nodes.

In FIG. 21, a distributed storage system 10B includes N (N is an integer of two or more) distributed FS servers 51A to 51C and one or more shared storage arrays 6A. In the distributed FS server 51A, logical nodes 61A to 63A are provided, and in the distributed FS server 51B, logical nodes 61B to 63B are provided, and in the distributed FS server 51C, logical nodes 61C to 63C are provided.

The shared storage array 6A can be referred to from the N distributed FS servers 51A to 51C and stores logical units for taking over the logical nodes 61A to 63A, 61B to 63B, 61C to 63C of different distributed FS servers 51A to 51C among the distributed FS servers 51A to 51C The shared storage array 6A includes data LU 71A to 73A for storing user data for each of the logical nodes 61A to 63A, 61B to 63B, 61C to 63C . . . , and management LU 81A to 83A . . . for storing logical node control information 91A to 93A . . . for each of the logical nodes 61A to 63A, 61B to 63B, 61C to 63C . . . . Each of the logical node control information 91A to 93A . . . is information necessary for constituting the logical nodes 61A to 63A, 61B to 63B, 61C to 63C . . . .

The logical nodes 61A to 63A, 61B to 63B, 61C to 63C . . . constitute a distributed file system, and the distributed file system provides a storage pool 2 including the distributed FS servers 51A to 51C . . . to the host servers 1A to 1C.

In the distributed storage system 10B, by setting a granularity of the logical nodes 61A to 63A, 61B to 63B, 61C to 63C . . . sufficiently smaller than a target availability set in advance or specified in advance by the administrator, the overload after the failover can be avoided. Here, the availability refers to a usage rate of hardware constituting the distributed FS servers 51A to 51C . . . such as the CPU and network resource.

In the distributed storage system 10B, by increasing the number of logical nodes operating per distributed FS servers 51A to 51C . . . , a total value of the load and the target availability per logical node 61A to 63A, 61B to 63B, 61C to 63C . . . does not exceed 100%. In this way, by determining the number of logical nodes per distributed FS server 51A to 51C . . . , it is possible to avoid overloading the distributed FS servers 51A to 51C . . . after the failover when operating with a load equal to or less than the target availability.

Specifically, it is assumed that the distributed FS server 51A becomes unable to respond due to a hardware failure or a software failure, and access to the data managed by the distributed FS server 51A is disabled (A201).

Next, a distributed FS server other than the distributed FS server 51A is selected as the failover destination, and the distributed FS server selected as the failover destination switches LU paths of the data LU 71A to 73A and the management LU 81A to 83A allocated to the logical nodes 61A to 63A of the distributed FS server 51A to itself for each of the logical nodes 61A to 63A, and attaches the LU paths (A202).

Next, each distributed FS server selected as the failover destination starts the logical nodes 61A to 63A using the data LU 71A to 73A and the management LU 81A to 83A of the logical nodes 61A to 63A which each distributed FS server is responsible for, and resumes the service (A203).

Next, after the failure recovery of the distributed FS server 51A, each distributed FS server selected as the failover destination stops the logical nodes 61A to 63A which the distributed FS serves themselves are responsible for, and detaches the data LU 71A to 73A and the management LU 81A to 83A allocated to the logical nodes 61A to 63A (A204). Thereafter, the distributed FS server 51A attaches the data LU 71A to 73A and the management LU 81A to 83A allocated to the logical nodes 61A to 63A to the distributed FS server 51A.

Next, the distributed FS server 51A resumes the service by staring the logical nodes 61A to 63A on the distributed FS server 51A by using the data LU 71A to 73A and the management LU 81A to 83A attached in A204 (A205).

In the distributed storage system 10A of FIG. 1, the number of logical nodes in the initial state, which is one per distributed FS server 51A to 51E, increases in accordance with the target availability. As a result, in the distributed storage system 10A, a distributed FS server belonging to the same storage pool is not selected as the failover destination (A102). In contrast, in the distributed storage system 10B of FIG. 21, the distributed FS server in the same storage pool 2 can be selected as the failover destination (A202). Therefore, in the distributed storage system 10B, the overload of the distributed FS server after the failover can be avoided without dividing the storage pool.

Also in the distributed storage system 10B, a similar system configuration as that of FIG. 2 can be used, a similar hardware configuration as that of FIGS. 3 to 6 can be used, and a similar data structure as that of FIGS. 7 to 14 can be used.

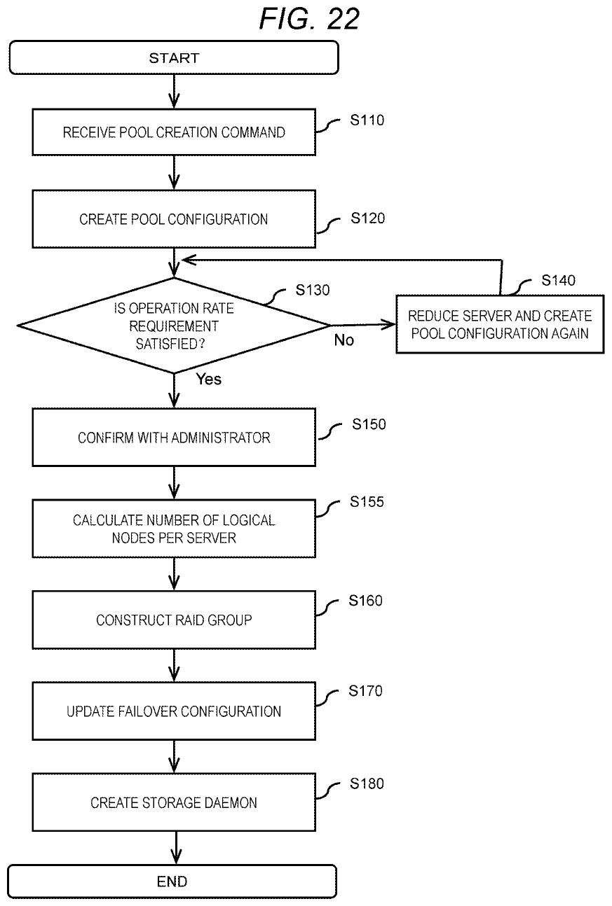

FIG. 22 is a flowchart showing an example of a storage pool creation processing of the storage system according to the second embodiment.

In FIG. 22, in this storage pool creation processing, the processing of S155 is added between the processing of S150 and the processing of S160 of FIG. 15.

In the processing of S155, the management program P17 calculates the number of logical nodes NL per distributed FS server with respect to the target availability α. At this time, the number of logical nodes NL can be given by the following Formula (2).

$$NL = \frac{1}{1 - α} - 1 \qquad ( Formula 2 )$$

For example, when the target availability is set to 0.75, the number of logical nodes per distributed FS server is 3. In the case where the availability is 0.75 when the number of logical nodes is 3, a resource usage rate per logical node is 0.25, so that the resource usage rate is 1 or less even if the failover occurs in another distributed FS server.

After S160, the management program P17 prepares a logical node corresponding to the number of logical nodes per distributed FS server, and performs RAID construction, failover configuration update, and storage daemon creation.

In S250 of FIG. 16, the distributed storage system 10B specifies a server with a low load as the failover destination regardless of the storage pool configuration. In addition, the distributed storage system 10B sets different failover destinations for all the logical nodes on the failed node. In S270, a daemon start instruction is sent to the failover destination of all the logical nodes on the failed node.

In addition, in the distributed storage system 10B, the processing illustrated in FIGS. 17 to 19 is equal in the distributed storage system 10A, except that the number of logical nodes per distributed FS server is plural.

Although the embodiments of the invention are described above, the above embodiments are described in detail to describe the invention in an easy-to-understand manner, and the invention is not necessarily limited to these having all the configurations described. It is possible to replace a part of configuration in a certain example with configuration in another example, and it is also possible to add configuration of another example to configuration of a certain example. In addition, apart of the configuration of each embodiment can be added, deleted, or replaced with another configuration. The configuration of the drawing shows what is considered to be necessary for the description and does not necessarily show all the configurations of the product.

Although the embodiments are described using a configuration using a physical server, the invention can also be applied to a cloud computing environment using a virtual machine. The cloud computing environment is configured to operate a virtual machine/container on a system/hardware configuration that is abstracted by a cloud provider. In this case, the server illustrated in the embodiment will be replaced by a virtual machine/container, and the storage array will be replaced by block storage service provided by the cloud provider.

In addition, although the logical node of the distributed file system is constituted by the distributed FS control daemon and the LU in the embodiments, the logical node can also be used by using the distributed FS server as the VM.

What is claimed is:

1. A storage system comprising:
a plurality of servers; and
a shared storage storing data and shared by the plurality of servers, wherein
each of the plurality of servers includes one or a plurality of logical nodes,
the plurality of logical nodes of the plurality of servers form a distributed file system in which a storage pool is provided, and any one of the logical nodes processes user data input to and output from the storage pool, and inputs and outputs the user data to and from the shared storage, and
the logical node is configured to migrate between the servers.

2. The storage system according to claim 1, wherein
the shared storage holds the user data related to a logical node and control information used for accessing the user data, and
in a migration of the logical node between the servers, a host switches an access path for accessing the server from a migration source server to a migration destination server, and refers to the control information and the user data in the shared storage of a logical server related to the migration from the migration source server.

3. The storage system according to claim 2, wherein
when a failure occurs in the migration source server, the logical node migrates to the migration destination server, and
when the migration source server recovers from the failure, the logical node is returned from the migration destination server to the migration source server.

4. The storage system according to claim 2, wherein
a plurality of storage pools formed from a plurality of logical nodes are provided respectively, and
a server having no logical node belonging to the same storage pool as the logical node related to the migration is selected as the migration destination server.

5. The storage system according to claim 2, wherein the migration source server and the migration destination server belong to different storage pools.

6. The storage system according to claim 2, wherein a management unit provided in any one of the servers selects the logical node to be migrated and the migration destination server.

7. The storage system according to claim 6, wherein the management unit selects the logical node to be migrated and the migration destination server based on a load state of the server.

8. The storage system according to claim 6, wherein the management unit selects a server for installing a logical node to be allocated to the storage pool based on an operation state of the storage pool.

9. The storage system according to claim 6, wherein the management unit determines the number of logical nodes operating per server based on a resource usage rate, and migrates the logical node.

10. A control method of a storage system,
the storage system including:
a plurality of servers; and
a shared storage storing data and shared by the plurality of servers,
the control method of the storage system comprising:
disposing a plurality of logical nodes in the plurality of servers, and forming a distributed file system that provides a storage pool by the plurality of logical nodes of the plurality of servers;
processing user data input to and output from the storage pool and inputting and outputting the user data to and from the shared storage by any one of the logical nodes forming the distributed file system; and
making the logical node migrate between the servers.
